(19) United States
(12) Patent Application Publication
(10) Pub. No.: US 2025/0306894 A1
(43) Pub. Date: Oct. 2, 2025

(54) VEHICLE CONTROL SYSTEM AND VEHICLE CONTROL METHOD

(71) Applicant: HONDA MOTOR CO., LTD., Tokyo (JP)

(72) Inventors: Tomoya Kitano, Tokyo (JP); Tetsushi Otaki, Tokyo (JP); Takashi Tsujioka, Tokyo (JP); Yuki Nomo, Tokyo (JP); Koji Kajiwara, Tokyo (JP); Hirofumi Segawa, Tokyo (JP); Kohsuke Nakamura, Tokyo (JP); Satoshi Kotoura, Tokyo (JP)

(21) Appl. No.: 19/010,351

(22) Filed: Jan. 6, 2025

(30) Foreign Application Priority Data
Mar. 27, 2024 (JP) 2024-051389

(51) Int. Cl. G06F 8/65; B60R 25/01; B60R 25/24; B60R 25/30; B60W 50/00; B60W 50/14; G07C 9/00

(52) U.S. Cl. CPC G06F 8/65; B60R 25/01; B60R 25/24; B60R 25/305; B60W 50/14; G07C 9/00309; B60W 2050/0083; B60W 2050/146; B60W 2420/403; B60W 2540/043; B60W 2540/215; G07C 2009/00793; G07C 2009/00984

(57) ABSTRACT

A vehicle control system includes a key authentication ECU, an image authentication ECU, a door lock mechanism that locks a door of a vehicle, a touch panel that receives an operation; and a central ECU that causes a touch panel mounted in the vehicle to display a second setting screen that receives a setting of execution allowance for a program update for the image authentication ECU and a setting of necessity of locking of the vehicle after alighting in a case where a communication state between the key authentication ECU and a mobile device is communication-disabled and an update program for updating a program being executed by the image authentication ECU is acquired and that controls the image authentication ECU and the lock mechanism in accordance with a setting received on the second setting screen.

### INCORPORATION BY REFERENCE

The present application claims priority under 35 U.S.C. § 119 to Japanese Patent Application No. 2024-051389 filed on Mar. 27, 2024. The content of the application is incorporated herein by reference in its entirety.

### BACKGROUND OF THE INVENTION

### Field of the Invention

The present invention relates to a vehicle control system and a vehicle control method.

### Description of the Related Art

Conventionally, a program rewriting system has been proposed which updates a program for a computer mounted on a vehicle (see Japanese Patent Laid-Open No. 2006-082648, for example).

### SUMMARY OF THE INVENTION

In recent years, a plurality of devices are mounted on a vehicle which lock and unlock a lock mechanism for the vehicle. By the way, when a passenger does not carry a device for canceling locking/unlocking of a vehicle such as an electronic key and starts updating a program in an electronic control device which authenticates a passenger, canceling the locking of the vehicle cannot be performed, which may cause problems such as the passenger being unable to get in the vehicle or being unable to move the vehicle until the program update is complete.

In order to solve the problem above, it is an object of the subject application to improve the convenience of the passenger by addressing a problem that may occur during a program update for a vehicle, and thus improve the safety. Consequently, traffic safety may further be improved, contributing to the development of a sustainable transportation system.

### Solution to Problem

As a first aspect for achieving the object above, there is provided a vehicle control system, including a first control device that acquires first authentication information via wireless communication with a mobile device and controls locking/unlocking of a vehicle based on the acquired first authentication information, a second control device that acquires second authentication information based on a captured image from a camera and controls locking/unlocking of the vehicle based on the acquired second authentication information, a lock mechanism that locks a door of the vehicle, a receiving device that receives an operation, and an update management device that causes a vehicle-mounted display device mounted in the vehicle to display a setting screen that receives a setting of execution allowance for a program update for the second control device and a setting of necessity of locking of the vehicle after alighting in a case where a communication state between the first control device and the mobile device is communication-disabled and an update program for updating a program being executed by the second control device is acquired and
that controls the second control device and the lock mechanism in accordance with a setting received on the setting screen.

In the vehicle control system, the update management device may be configured to cause the setting screen to display a predetermined guidance if the program update for the second control device fails.

In the vehicle control system, the update management device may be configured to include an alighting detecting unit that detects alighting of a passenger from the vehicle, and, if an operation for selecting that locking of the vehicle after alighting is necessary is received by the receiving device, and if alighting of the passenger is detected by the alighting detecting unit, transmit an instruction signal that instructs locking of a door of the vehicle to the lock mechanism, and perform a program update for the second control device after transmitting the instruction signal.

In the vehicle control system, the vehicle control system may be configured to include a drive source control device that controls a drive source mounted in the vehicle, and the update management device may be configured to include an alighting detecting unit that detects alighting of a passenger from the vehicle, and, if an operation for selecting that locking of the vehicle after alighting is not necessary is received by the receiving device, and if alighting of the passenger is detected by the alighting detecting unit, transmit an instruction signal that instructs prohibition of driving of the drive source to the drive source control device.

In the vehicle control system, the update management device may be configured to perform a program update for the second control device by keeping a door of the vehicle unlocked without transmitting an instruction signal that instructs locking of the door of the vehicle to the lock mechanism.

As a second aspect for achieving the object above, there is provided a control method for a vehicle control system, the vehicle control system including a first control device that acquires first authentication information via wireless communication with a mobile device and controls locking/unlocking of a vehicle based on the acquired first authentication information, a second control device that acquires second authentication information based on a captured image from a camera and controls locking/unlocking of the vehicle based on the acquired second authentication information, a lock mechanism that locks a door of the vehicle, a receiving device that receives an operation, and an update management device that manages updating on a program performed by the first control device and the second control device, the control method for the vehicle control system including causing a vehicle-mounted display device mounted in the vehicle to display a setting screen that receives a setting of execution allowance for a program update for the second control device and a setting of necessity of locking of the vehicle after alighting in a case where a communication state between the first control device and the mobile device is communication-disabled and an update program for updating a program being executed by the second control device is acquired and controlling the second control device and the lock mechanism in accordance with a setting received on the setting screen.

### Advantageous Effect of Invention

According to the aforementioned vehicle control system and vehicle control method, by receiving how a problem that may occur during a program update for the vehicle is to be addressed from a passenger, the convenience of the passenger can be improved.

### BRIEF DESCRIPTION OF THE DRAWINGS

FIG. 1 is a system configuration diagram showing a configuration of a vehicle control system;

FIG. 2 is a block diagram showing a configuration of a central ECU;

FIG. 3 is a diagram showing an example of an allowance request screen;

FIG. 4 is a flowchart showing operations of a central ECU according to a first embodiment;

FIG. 5 is a diagram showing an example of a first setting screen;

FIG. 6 is a diagram showing an example of a second setting screen;

FIG. 7 is a flowchart showing operations of a central ECU according to a second embodiment;

FIG. 8 is a diagram showing an example of a contact table;

FIG. 9 is a flowchart showing operations of a central ECU according to a third embodiment; and

FIG. 10 is a flowchart showing operations of the central ECU according to the third embodiment.

### DETAILED DESCRIPTION OF THE INVENTION

### [1. Configuration of Vehicle Control System of First Embodiment]

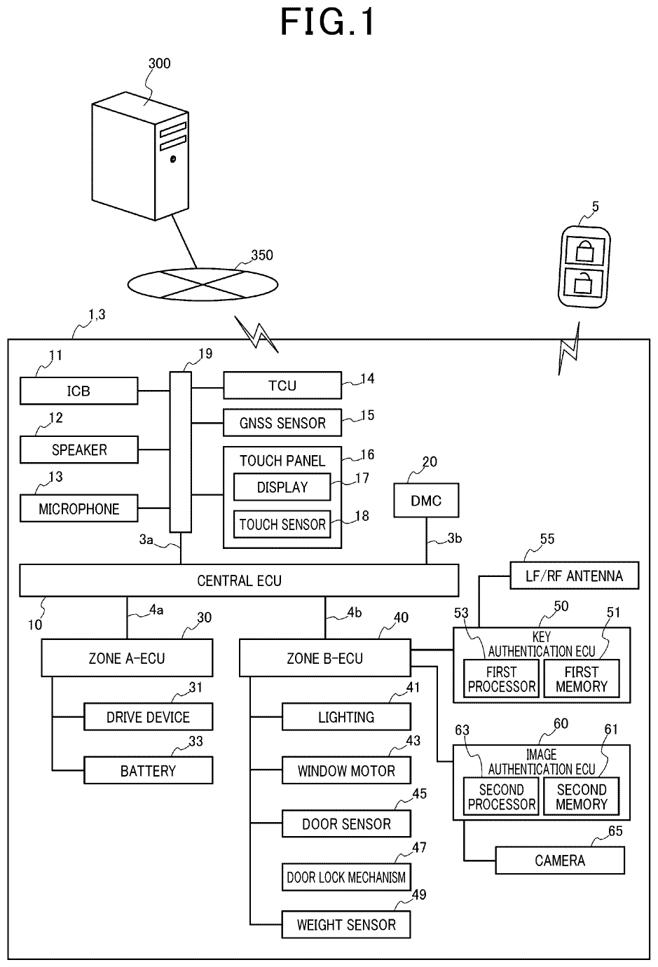

FIG. 1 is a system configuration diagram showing a configuration of a vehicle control system 1 mounted in a vehicle 3. The vehicle control system 1 is configured such that a central ECU (Electronic Control Unit) 10 that is an electronic control device functioning as a central gateway and an electronic control device having a program to be updated are connected data-communicably with each other. The central ECU 10 corresponds to an update management device.

A TCU (Telematics Control Unit) 14 that is a wireless device compatible with the mobile communication system communication standard is connected to the central ECU 10. The central ECU 10 executes OTA (Over The Air) management by utilizing the TCU 14. The OTA management includes control that downloads an update program for an electronic control device provided in the vehicle 3 from a server apparatus 300 over a network 350 and applies the downloaded update program to the electronic control device.

Also, the central ECU 10 is connected to a plurality of communication lines including first communication lines 3a, 3b and second communication lines 4a, 4b. The central ECU 10 provides a gateway function that manages swapping of communication data between those communication lines.

The first communication lines 3a, 3b and the second communication lines 4a, 4b are configured by a bus that performs communication compatible with a standard such as CAN or Ethernet (registered trademark) or a communication line that performs P2P (Peer to Peer) communication. The first communication lines 3a, 3b may be configured by a plurality of communication lines that perform communications compliant with the same standard or may be configured by a plurality of communication lines that perform communications compliant with different standards. The same is also true for the second communication lines 4a, 4b.

An ICB (Infotainment Control Box) 11, a speaker 12, and a microphone 13 are connected to the first communication line 3a via an in-vehicle connection link 19. Also, a TCU (Telematics Control Unit) 14, a GNSS (Global Navigation Satellite System) sensor 15, a touch panel 16 are connected to the in-vehicle connection link 19. The touch panel 16 includes a display 17 and a touch sensor 18. The touch panel 16 corresponds to a vehicle mounted display device.

The in-vehicle connection link 19 is configured by a plurality of communication transmission paths compliant with various communication standards. The in-vehicle connection link 19 may include a plurality of communication networks, for example. In this case, the plurality of communication networks may be connected to each other through a device and the like having a gateway function. Also, the in-vehicle connection link 19 may include a communication network for performing P2P communication. For the communication network, various communication buses that are compliant with various standards for performing network communication can be adopted. Examples of the various standards may include CAN, Ethernet, USB (Universal Serial Bus), LIN (Local Interconnect Network), and LVDS (Low Voltage Differential Signaling) but may include other standards.

The ICB 11 is an IVI (In-Vehicle Infotainment)-ECU. The ICB 11 provides various kinds of information and entertainment to passengers of the vehicle by employing the speaker 12, the microphone 13, the GNSS sensor 15, the touch panel 16 and so on.

A DMC (Driver Monitoring Camera) 20 that monitors a driver is connected to the first communication line 3b.

A zone A-ECU 30 is connected to the second communication line 4a. A drive device 31 and a battery 33 are connected to the zone A-ECU 30. The drive device 31 is a motor or an internal combustion engine that drives the vehicle 3, for example. The zone A-ECU 30 corresponds to a drive source control device.

A zone B-ECU 40 is connected to the second communication line 4b. A lighting 41, a window motor 43, a door sensor 45, a door lock mechanism 47, and a weight sensor 49 are connected to the zone B-ECU 40.

The lighting 41 includes, for example, a head lamp, a tail lamp, a direction indicator lamp and so on. The window motor 43 opens and closes a vehicle window. The door sensor 45 detects an operation on a vehicle door. The door lock mechanism 47 includes a door lock and an actuator and performs locking and unlocking of a door of the vehicle 3. The weight sensor 49 is placed on a seat on which a passenger sits and detects a weight applied to the seat. The weight sensor 49 outputs sensor data indicating a weight applied to the seat to the zone B-ECU 40. Describing the example including the weight sensor 49 according to this embodiment, a person seated or non-seated (leaving the seat) may be detected based on a detection result from a pressure sensor or a motion sensor instead of the weight sensor 49. The zone B-ECU 40 outputs the sensor data input from the weight sensor 49 to the central ECU 10.

Also, a key authentication ECU 50 and an image authentication ECU 60 are connected to the zone B-ECU 40. The key authentication ECU 50 corresponds to a first control device. The image authentication ECU 60 corresponds to a second control device. A LF/RF antenna 55 that performs wireless communication with a mobile device 5 is connected to the key authentication ECU 50. The mobile device 5 is an electronic device having a wireless communication function and is called a smart key or a FOB key. Also, the mobile device 5 may be a smart phone utilized as a digital key.

The key authentication ECU 50 is an electronic control device including a first memory 51 and a first processor 53. The first memory 51 is configured by, for example, a nonvolatile semiconductor memory or a volatile and nonvolatile semiconductor memory. The first processor 53 is a processing unit configured by a CPU (Central Processing Unit) or an MPU (Micro Processor Unit). The first processor 53 may be configured by a single processor or may be configured by a plurality of processors.

The first memory 51 stores a first program that is a control program to be executed by the first processor 53 and a key ID. The key ID is an ID for identifying the mobile device 5 by the vehicle control system 1, and a different value for each mobile device 5 is assigned thereto.

The first processor 53 executes the first program to perform authentication processing. When receiving a key ID of the mobile device 5 via the LF/RF antenna 55, the first processor 53 determines whether the received key ID and the key ID stored in the first memory 51 are matched or not. The key ID corresponds to first authentication information. If the received key ID and the key ID stored in the first memory 51 are matched, the first processor 53 instructs the zone B-ECU 40 to unlock or lock the door lock. The zone B-ECU 40 instructs to unlock or lock the door lock to the door lock mechanism 47 in accordance with an instruction from the key authentication ECU 50. Also, the key authentication ECU 50 outputs information indicating a communication state between the mobile device 5 and the LF/RF antenna 55 to the zone B-ECU 40. The zone B-ECU 40 outputs the information indicating a communication state input from the key authentication ECU 50 to the central ECU 10.

A camera 65 is connected to the image authentication ECU 60. The camera 65 is a digital camera and is, for example, installed in the vehicle 3 such that the face of a passenger present externally to the vehicle on the driver side can be imaged. The camera 65 is placed on, for example, a B-pillar, a roof edge, a side mirror or the like on the driver side.

The image authentication ECU 60 is an electronic control device including a second memory 61 and a second processor 63. The second memory 61 is configured by, for example, a nonvolatile semiconductor memory or a volatile and nonvolatile semiconductor memory. The second processor 63 is a processing unit configured by a CPU or an MPU.

The second memory 61 stores a second program that is a control program to be executed by the second processor 63 and feature value data. The feature value data is data indicating a feature of the face of a passenger and is extracted from a captured image acquired by imaging the face of the passenger.

The image authentication ECU 60 operates the camera 65 to acquire a captured image by the camera 65. The image authentication ECU 60 extracts a feature value of a face portion included in a captured image by the camera 65 and authenticates a user based on a comparison result between the extracted feature value and a feature value stored in the second memory 61. The feature value of a face portion corresponds to second authentication information. If the feature values are matched, the image authentication ECU 60 instructs the zone B-ECU 40 to unlock the door lock. The zone B-ECU 40 instructs to unlock the door lock to the door lock mechanism 47 in accordance with an instruction from the image authentication ECU 60.

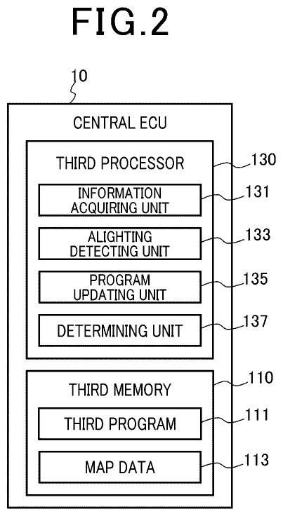

FIG. 2 is a block diagram showing a configuration of the central ECU 10.

A configuration of the central ECU 10 is described with reference to FIG. 2.

The central ECU 10 is an electronic control device including a third memory 110 and a third processor 130. The third memory 110 is configured by, for example, a nonvolatile semiconductor memory or a volatile and nonvolatile semiconductor memory. The third memory 110 stores a third program 111 to be executed by the third processor 130 and map data 113. Also, the third memory 110 is used as a calculation area for the third processor 130.

The third processor 130 is a processing unit configured by a CPU or an MPU. The third processor 130 may be configured by a single processor or may be configured by a plurality of processors.

The central ECU 10 includes an information acquiring unit 131, an alighting detecting unit 133, a program updating unit 135, and a determining unit 137 as functional components. These functional components are functions acquired by performing calculations by executing the third program 111 by the third processor 130.

The information acquiring unit 131 acquires information from the key authentication ECU 50 and the zone B-ECU 40. For example, the information acquiring unit 131 acquires information indicating a communication state with the mobile device 5 from the key authentication ECU 50. Also, the information acquiring unit 131 acquires information indicating a state of a door lock from the zone B-ECU 40 and sensor data from the weight sensor 49.

The alighting detecting unit 133 detects alighting of a passenger. The alighting detecting unit 133 detects alighting of a passenger based on sensor data from the weight sensor 49. Also, the alighting detecting unit 133 may determine passenger's alighting based on a communication state between the key authentication ECU 50 and the mobile device 5. For example, the alighting detecting unit 133 may determine that a passenger has alighted from the vehicle 3 if the communication state between the key authentication ECU 50 and the mobile device 5 is changed from a communication enabled state to a communication disabled state.

When there is an update for a program being executed by an electronic control device mounted in the vehicle 3, the program updating unit 135 downloads the update program that is a program having been updated from the server apparatus 300. The program updating unit 135 stores the acquired update program temporarily in the third memory 110. The program updating unit 135 causes the target electronic control device to be updated with the downloaded program at a predetermined time.

Also, if the downloaded update program is a program for updating the second program being executed by the image authentication ECU 60 and if the determining unit 137 determines that the update for the program is allowed, the program updating unit 135 causes the image authentication ECU 60 to update the second program being executed by the image authentication ECU 60 with the update program.

If the update program downloaded by the program updating unit 135 is a program for updating the second program, the determining unit 137 determines whether the update for the update program is to be allowed or not for the image authentication ECU 60 based on the communication state between the key authentication ECU 50 and the mobile device 5.

When the key authentication ECU 50 and the mobile device 5 are in a communication enabled state, the determining unit 137 allows the image authentication ECU 60 to update the program.

For example, when the key authentication ECU 50 and the mobile device 5 are in a communication enabled state and if an allowance operation for allowing the image authentication ECU 60 to update the program is received and taking out of the mobile device 5 to outside of the vehicle is detected, the determining unit 137 allows the program updating unit 135 to update the second program of the image authentication ECU 60.

Also, even when the key authentication ECU 50 and the mobile device 5 are in a communication enabled state but if an allowance operation for allowing the image authentication ECU 60 to update the program is not received and if taking out of the mobile device 5 to outside of the vehicle is detected, the determining unit 137 allows the program updating unit 135 to update the second program of the image authentication ECU 60.

With respect to the taking out of the mobile device 5 from inside to outside of the vehicle, if, for example, the communication state of the key authentication ECU 50 and the mobile device 5 is changed from a communication enabled state to a communication disable state and the alighting detecting unit 133 determines that the alighting of a passenger has been detected, the determining unit 137 determines that the mobile device 5 has been taken out of the vehicle.

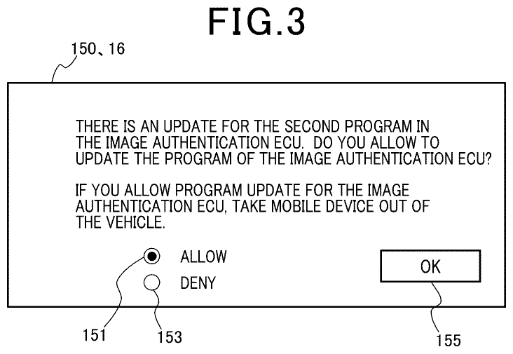

FIG. 3 is a diagram showing an example of an allowance request screen 150 to be displayed on the touch panel 16 by the central ECU 10 when there is an update for the second program. The allowance request screen 150 corresponds to an example of a guidance screen.

The allowance request screen 150 displays a guidance that there is an update for the second program being executed by the image authentication ECU 60 and a guidance that inquires about whether the program update for the image authentication ECU 60 is allowed or not. Also, the allowance request screen 150 displays a guidance that requests to take out the mobile device 5 if the program update for the image authentication ECU 60 is allowed and there is a movement to outside of the vehicle.

Also, the allowance request screen 150 displays a radio button 151 to allow the program update, a radio button 153 to deny it, and an OK button 155.

In order to allow the program update, a passenger selects the radio button 151 and presses the OK button 155. In order to deny the program update, a passenger selects the radio button 153 and presses the OK button 155.

Next, a case is described where the determining unit 137 receives an allowance operation that allows the program update on the allowance request screen 150 but a passenger has alighted with the mobile device 5 left inside the vehicle.

If the determining unit 137 determines that alighting of a passenger is detected by the alighting detecting unit 133 and that the mobile device 5 is being left inside the vehicle, information on the latitude and longitude indicating the position of the vehicle 3 is acquired from the GNSS sensor 15. With reference to map data 113 based on the acquired information on the latitude and longitude, the determining unit 137 acquires facility information on the facility where the vehicle 3 is parked. The GNSS sensor 15 and the central ECU 10 function as a position detecting device.

The determining unit 137 first determines whether the acquired information on the latitude and longitude indicates the position registered as home or not. If the acquired information on the latitude and longitude indicates the position registered as home, the determining unit 137 does not determine whether the program update for the image authentication ECU 60 is to be allowed or not based on the communication state between the mobile device 5 and the key authentication ECU 50. However, whether the update for the second program being executed by the second control device being executed is to be allowed or not is determined. If the position of the vehicle is a position registered as home, a mobile device such as a spare is taken out of the home to unlock the vehicle so that the possibility of occurrence of situations that the passenger cannot get on the vehicle or the vehicle cannot be caused to run can be low.

The determining unit 137 acquires a predicted time for a stop time for the passenger to stop by the facility indicated by the facility information based on the acquired facility information. For example, the determining unit 137 stores in the third memory 110 the type of facility that the passenger has stopped by in the past and an average value of the stop times for stopping by the type of facility as action history. The type of facility is information indicating a type of facility such as a supermarket, a convenience store, an amusement park, and a karaoke parlor, for example. The determining unit 137 may acquire an average value of stop times for each facility and store in the third memory 110. Alternatively, it may be configured such that, for each facility or for each type of facility, an average value of stop times of a plurality of users is acquired and is registered with a server apparatus, not shown. The determining unit 137 acquires the type of facility indicated by the acquired facility information and transmits the information on the acquired type and an acquisition request for an average value of stop times to the server apparatus. When receiving the acquisition request from the vehicle 3, the server apparatus acquires the type of facility indicated by the information included in the acquisition request and acquires an average value of the stop time for the facility corresponding to the acquired type. The server apparatus transmits the acquired average value of stop times to the vehicle 3 from which the acquisition request has been received.

When acquiring the predicted time for the stop time for the passenger to stop by the facility, the determining unit 137 compares the predicted time for the acquired stop time and an update time required to update the second program. If the stop time predicted time is longer than the update time, the determining unit 137 allows the image authentication ECU 60 to update the second program. Also, if the stop time predicted time is shorter than the update time, the determining unit 137 does not allow the image authentication ECU 60 to update the second program.

Also, when the key authentication ECU 50 and the mobile device 5 are in a communication disabled state, the determining unit 137 prohibits the image authentication ECU 60 to update the program. Also, when the key authentication ECU 50 and the mobile device 5 are in a communication disabled state, the determining unit 137 prohibits to display the allowance request screen 150 shown in FIG. 3 on the touch panel 16.

Also, while the key authentication ECU 50 is performing update of the first program, the determining unit 137 does not allow the image authentication ECU 60 to update the second program. That is, the determining unit 137 manages the execution times for update processing by the key authentication ECU 50 and the image authentication ECU 60 such that update processing for updating the first program by key authentication ECU 50 and the update processing for updating the second program by the image authentication ECU 60 do not overlap.

### [2. Operations of Central ECU of First Embodiment]

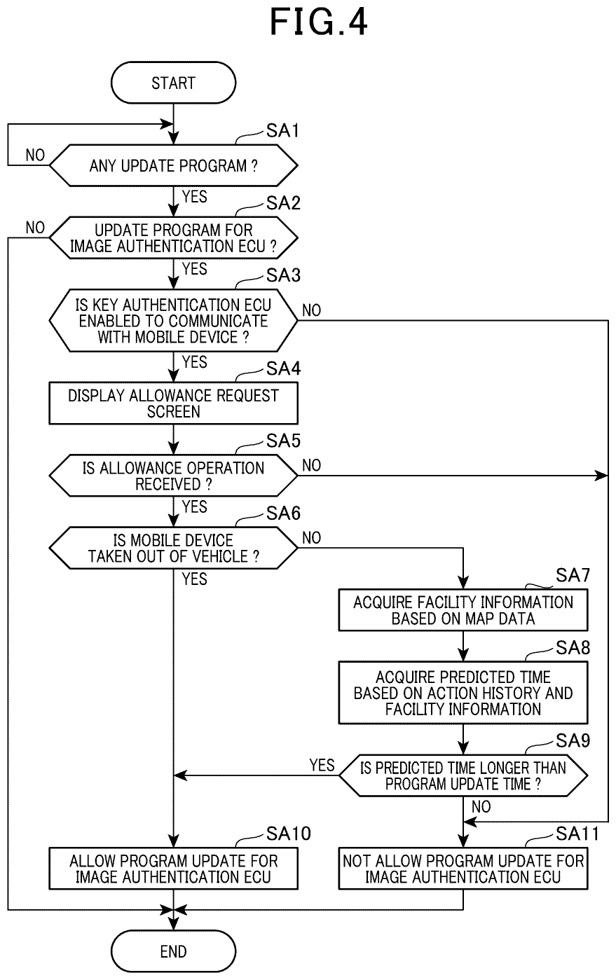

FIG. 4 is a flowchart showing operations of the central ECU 10. Operations of the central ECU 10 are described with reference to the flowchart shown in FIG. 4.

The central ECU 10 determines whether there is an update program downloaded from the server apparatus 300 or not (step SA1). If there is not downloaded update program (step SA1/NO), the central ECU 10 waits until an update program is downloaded from the server apparatus 300.

If there is a downloaded update program (step S1A/YES), the central ECU 10 determines whether the downloaded update program is an update program for the second program being executed by the image authentication ECU 60 or not (step SA2).

If the downloaded update program is not an update program for the second program (step SA2/NO), the central ECU 10 ends the processing flow and executes another processing flow.

If the downloaded update program is an update program for the second program (step SA2/YES), the central ECU 10 determines whether the key authentication ECU 50 is in a communication enabled state with the mobile device 5 or not (step SA3).

When the key authentication ECU 50 and the mobile device 5 are in a communication disabled state (step SA3/NO), the central ECU 10 does not allow the image authentication ECU 60 to update the second program (step SA11) and ends the processing flow.

When the key authentication ECU 50 and the mobile device 5 are in a communication enabled state (step SA3/YES), the central ECU 10 causes to display an allowance request screen 150 that requests the passenger to allow the update for the second program on the touch panel 16 (step SA4). This allowance request screen 150 displays the radio button 151 to allow the program update, the radio button 153 to deny it, and the OK button 155. Also, the allowance request screen 150 displays a guidance that requests to take out the mobile device 5 if the program update for the image authentication ECU 60 is allowed and there is a movement to outside of the vehicle. In order to allow the program update, the passenger selects the radio button 151 and presses the OK button 155.

The central ECU 10 determines whether an allowance operation has been received or not (step SA5). If the allowance operation is not received and a denial operation is received (step SA5/NO), the central ECU 10 does not allow the image authentication ECU 60 to update the second program (step SA11).

If an allowance operation has been received (step SA5/YES), the central ECU 10 determines whether the passenger has alighted from the vehicle 3 with the mobile device 5 or not (step SA6). The central ECU 10 detects alighting of a passenger based on sensor data from the weight sensor 49. If the communication state of the key authentication ECU 50 and the mobile device 5 is changed from a communication enabled state to a communication disable state and if alighting of a passenger has been detected, the central ECU 10 determines that the mobile device 5 has been taken out of the vehicle.

If it is determined that the mobile device 5 has been taken out of the vehicle (step SA6/YES), the central ECU 10 allows the image authentication ECU 60 to update the program (step SA10) and ends the processing flow.

Also, if the mobile device 5 is not taken out of the vehicle (step SA6/NO), the central ECU 10 acquires information on the latitude and longitude indicating the position of the vehicle 3, which is calculated by the GNSS sensor 15. With reference to map data 113 based on the acquired information on the latitude and longitude, the central ECU 10 acquires facility information on the facility having the acquired latitude and longitude within its premise (step SA7). Also, if there is no facility including the acquired latitude and longitude within its premise, the central ECU 10 may acquire facility information on facility within a predetermined range from the latitude and longitude.

Next, the central ECU 10 acquires a predicted time for a stop time for stopping by the facility indicated by the facility information based on the acquired facility information and the action history of the passenger (step SA8). For example, in the third memory 110, the type of facility that the passenger has stopped by in the past and an average value of the stop times for stopping by in the past the type of facility are stored as action history. The central ECU 10 acquires an average value of the stop times for stopping by the facility corresponding to facility information as predicted time.

Next, the central ECU 10 determines whether the average value of stop times acquired in step SA8 is longer than the update time required for the program update by the image authentication ECU 60 (step SA9). If the stop time predicted time is longer than the update time (step SA9/YES), the central ECU 10 allows the image authentication ECU 60 to update the program (step SA10). Also, if the predicted time is shorter than or equal to the update time (step SA9/NO), the central ECU 10 does not allow the image authentication ECU 60 to update the program (step SA11) and ends the processing flow.

### [3. Operations of Central ECU of Second Embodiment]

A second embodiment is described next with reference to the attached drawings.

Since the configuration of the vehicle control system 1 of the second embodiment is identical to the first embodiment, the description on the configuration of the vehicle control system 1 is omitted.

According to the second embodiment, when an update program for the image authentication ECU 60 is downloaded from the server apparatus 300, the central ECU 10 inquires the key authentication ECU 50 about the communication state with the mobile device 5.

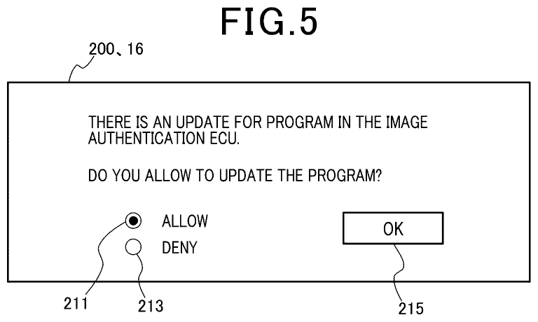

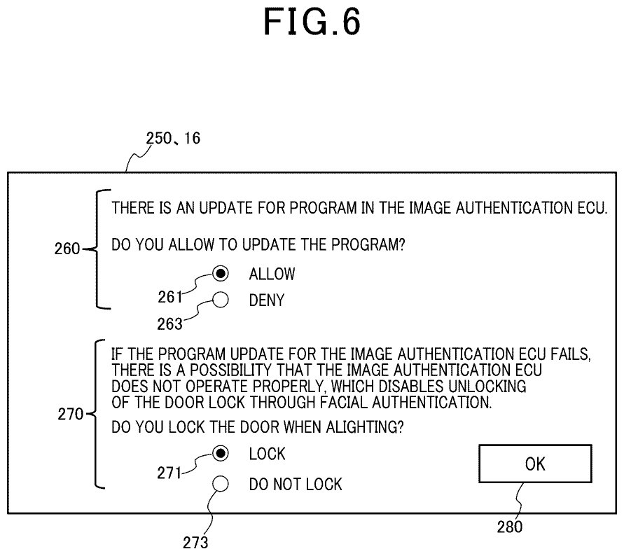

If a response that the communication state with the mobile device 5 is enabled is received from the key authentication ECU 50, the central ECU 10 causes the first setting screen 200 shown in FIG. 5 to be displayed on the touch panel 16. If a response that the communication state with the mobile device 5 is disabled is received from the key authentication ECU 50, the central ECU 10 causes the second setting screen 250 shown in FIG. 6 to be displayed on the touch panel 16.

FIG. 5 is a diagram showing an example of the first setting screen 200 to be displayed on the touch panel 16 by the central ECU 10.

The first setting screen 200 displays a guidance indication that notifies a program update for the image authentication ECU 60. Also, the first setting screen 200 displays a radio button 211 for selecting to “ALLOW” the program update, a radio button 213 for selecting to “DENY” it, and an OK button 215.

In order to allow the program update, a passenger selects the radio button 211 and presses the OK button 215. In order to deny the program update, a passenger selects the radio button 213 and presses the OK button 215.

FIG. 6 is a diagram showing an example of the second setting screen 250 to be displayed on the touch panel 16 by the central ECU 10. The second setting screen 250 corresponds to a setting screen.

The second setting screen 250 displays a first display field 260, a second display field 270, and an OK button 280.

The first display field 260 displays a guidance indication that notifies a program update for the image authentication ECU 60. Also, the first display field 260 displays a radio button 261 for selecting to “ALLOW” the program update and a radio button 263 for selecting to “DENY” it. In order to allow the program update, a passenger selects the radio button 261. In order not to allow the program update, a passenger selects the radio button 263.

The second display field 270 displays a warning notice that the program update for the image authentication ECU 60 has failed. The warning notice corresponds to a predetermined guidance. For example, if the program update for the image authentication ECU 60 has failed, the image authentication ECU 60 no longer operates, and the second display field 270 displays a guidance that there is a risk that the door lock cannot be unlocked through facial authentication. Also, the second display field 270 displays a guidance that inquires about whether the door lock is locked or not when the passenger alights. The second display field 270 displays a radio button 271 for selecting to “LOCK” and a radio button 273 for selecting to “NOT LOCK”. The radio buttons 271 and 273 displayed on the second display field 270 are buttons selectable if the radio button 261 is selected on the first display field 260.

In order to allow the program update for the image authentication ECU 60, a passenger selects the radio button 261. Also, in order to deny the program update for the image authentication ECU 60, a passenger selects the radio button 263. Furthermore, if the door is to be locked upon alighting, a passenger selects the radio button 271. Also, if the door is not locked upon alighting, a passenger selects the radio button 273. A passenger selects the radio button 261 or 263 and the radio button 271 or 273 and presses the OK button 280.

If the first setting screen 200 is displayed, the key authentication ECU 50 and the mobile device 5 are in a communication enabled state. Therefore, even by allowing the program update for the image authentication ECU 60, the passenger can get on the vehicle 3 by manipulating the mobile device 5. Accordingly, the central ECU 10 does not display a warning notice that the program update for the image authentication ECU 60 has failed on the first setting screen 200.

If the communication state between the key authentication ECU 50 and the mobile device 5 is communication-enabled and when the radio button 211 is selected on the first setting screen 200, the central ECU 10 determines that an allowance operation for allowing the program update for the image authentication ECU 60 has been received. In this case, if the alighting of a passenger is detected, the central ECU 10 instructs the zone B-ECU 40 to lock the door and allows the program update for the image authentication ECU 60. The zone B-ECU 40 locks the door lock by controlling the door lock mechanism 47 in accordance with an instruction from the central ECU 10.

Also, if the communication state between the key authentication ECU 50 and the mobile device 5 is communication-enabled and when the radio button 213 is selected on the first setting screen 200, the central ECU 10 determines that a denial operation for denying the program update for the image authentication ECU 60 has been received. In this case, the central ECU 10 prohibits the program update for the image authentication ECU 60 and does not cause the image authentication ECU 60 to perform the program update.

Also, if the communication state between the key authentication ECU 50 and the mobile device 5 is communication-disabled and when the radio buttons 261 and 271 are selected on the second setting screen 250, the central ECU 10 determines that an allowance operation for allowing the program update and a locking operation for locking the door lock have been received. In this case, if the alighting of a passenger is detected, the central ECU 10 instructs the zone B-ECU 40 to lock the door and allows the program update for the image authentication ECU 60. The zone B-ECU 40 locks the door by controlling the door lock mechanism 47 in accordance with an instruction from the central ECU 10.

Also, if the communication state between the key authentication ECU 50 and the mobile device 5 is communication-disabled and when the radio buttons 261 and 273 are selected on the second setting screen 250, the central ECU 10 determines that an allowance operation for allowing the program update and an unlock operation for not locking the door lock have been received. If the alighting of a passenger is detected, the central ECU 10 allows the image authentication ECU 60 to perform the program update but does not instruct the zone B-ECU 40 to lock the door.

Also, if the allowance operation for allowing the program update and the unlock operation for not locking the door lock are received, the central ECU 10 transmits an instruction to prohibit the driving by the drive device 31 to the zone A-ECU 30. Also, the central ECU 10 may be configured not to transmit an instruction signal for instructing to lock the door lock of the vehicle 3 to the zone A-ECU 30. The zone A-ECU 30 having received the instruction from the central ECU 10 prohibits the driving by the drive device 31 so that the vehicle 3 cannot run. This can prevent the vehicle 3 from being stolen. The prohibition of the driving by the drive device 31 is continued until, for example, a passenger operates the mobile device 5 and the key authentication ECU 50 receives the key ID of the mobile device 5. Also, the prohibition of the driving by the drive device 31 is continued until, for example, the program update for the image authentication ECU 60 completes and the image authentication ECU 60 authenticates a passenger from the captured image by the camera 65.

Also, if the communication state between the key authentication ECU 50 and the mobile device 5 is communication-disabled and when the radio button 263 is selected on the second setting screen 250, the central ECU 10 determines that a denial operation for denying the program update has been received. In this case, the central ECU 10 prohibits the program update for the image authentication ECU 60 and does not cause the image authentication ECU 60 to perform the program update.

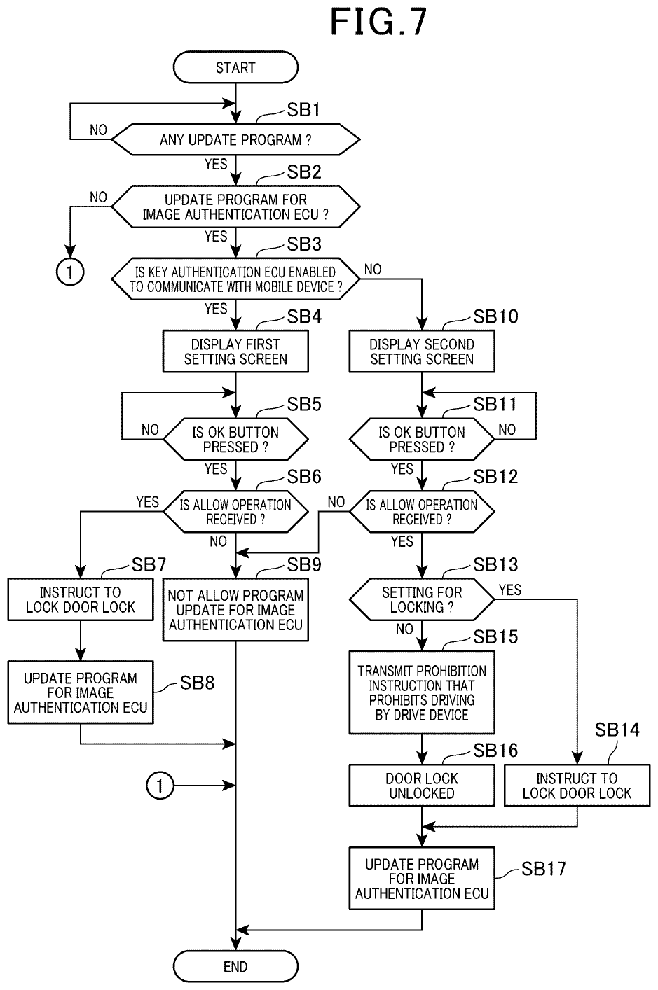

FIG. 7 is a flowchart showing operations of a central ECU 10 according to a second embodiment.

Operations of the central ECU 10 are described with reference to the flowchart shown in FIG. 7.

The central ECU 10 determines whether there is an update program downloaded from a server, not shown, or not (step SB1). If there is no downloaded update program (step SB1/NO), the central ECU 10 waits until an update program is downloaded from the server.

If there is a downloaded update program (step SB1/YES), the central ECU 10 determines whether the downloaded update program is an update program for the program being executed by the image authentication ECU 60 or not (step SB2).

If the downloaded update program is not an update program for the image authentication ECU 60 (step SB2/NO), the central ECU 10 ends the processing flow and executes another processing flow.

If the downloaded update program is an update program for the image authentication ECU 60 (step SB2/YES), the central ECU 10 inquires the key authentication ECU 50 about whether the communication state with the mobile device 5 is enabled or not. If acquiring a response that the communication state with the mobile device 5 is communication-enabled from the key authentication ECU 50 (step SB3/YES), the central ECU 10 causes the first setting screen 200 to be displayed on the touch panel 16 (step SB4). In accordance with a touch operation on the touch panel 16, the central ECU 10 changes the display of the first setting screen 200. For example, the central ECU 10 changes the radio button having a selected state in accordance with a touch operation to the radio button 211 or 213.

Next, the central ECU 10 determines whether the OK button 215 has been pressed or not (step SB5). If the OK button 215 has not been pressed (step SB5/NO), the central ECU 10 waits until the OK button 215 is pressed.

If the OK button 215 is pressed (step SB5/YES), the central ECU 10 determines whether an allowance operation for allowing the program update for the image authentication ECU 60 has been received on the first setting screen 200 or not (step SB6). If the allowance operation is received (step SB6/YES) and when alighting of a passenger from the vehicle 3 is detected, the central ECU 10 instructs the zone B-ECU 40 to lock the door lock (step SB7). The zone B-ECU 40 locks the door lock of the vehicle 3 by controlling the door lock mechanism 47 in accordance with an instruction from the central ECU 10. Next, the central ECU 10 allows the program update for the image authentication ECU 60 (step SB8).

Also, if the allowance operation for allowing the program update for the image authentication ECU 60 is received on the first setting screen 200 (step SB6/NO), the central ECU 10 does not allow the program update for the image authentication ECU 60 (step SB9) and ends this processing flow.

Next, operations of the central ECU 10 are described in a case where, in the determination in step SB3, a response that the communication with the mobile device 5 is communication-disabled is acquired from the key authentication ECU 50.

If acquiring a response that the communication state with the mobile device 5 is communication-disabled from the key authentication ECU 50 (step SB3/NO), the central ECU 10 causes the second setting screen 250 to be displayed on the touch panel 16 (step SB10).

Next, the central ECU 10 determines whether the OK button 215 has been pressed or not (step SB11). If the OK button 215 has not been pressed (step SB11/NO), the central ECU 10 waits until the OK button 215 is pressed.

If the OK button 280 is pressed (step SB11/YES), the central ECU 10 determines whether an allowance operation for allowing the program update for the image authentication ECU 60 has been received on the second setting screen 250 or not (step SB12). The central ECU 10 determines whether the radio button 261 in the first display field 260 is being selected or not and determines whether the allowance operation has been received or not.

If it is determined that the radio button 263 in the first display field 260 is being selected and the denial operation is received (step SB12/NO), the central ECU 10 does not allow the program update for the image authentication ECU 60 (step SB9) and ends this processing flow.

Also, if it is determined that the allowance operation has been received (step SB12/YES) when the selection of the radio button 261 in the first display field 260 has been received, the central ECU 10 determines whether a setting for locking the door lock upon alighting has been received or not (step SB13).

When the selection of the radio button 271 in the second display field 270 is received, the central ECU 10 determines that locking the door lock of the vehicle 3 upon alighting has been selected (step SB13/YES). In this case, the central ECU 10 instructs the zone B-ECU 40 to lock the door lock (step SB14). The zone B-ECU 40 locks the door lock of the vehicle 3 by controlling the door lock mechanism 47 in accordance with an instruction from the central ECU 10. Next, the central ECU 10 allows the program update for the image authentication ECU 60 (step SB17).

Also, the selection of the radio button 273 in the second display field 270 is received, the central ECU 10 determines that not-locking the door lock of the vehicle 3 upon alighting has been selected (step SB13/NO). In this case, the central ECU 10 transmits an instruction to prohibit the driving by the drive device 31 to the zone A-ECU 30 (step SB15) and does not instruct the zone B-ECU 40 to lock the door lock. Accordingly, the door lock of the vehicle 3 is left unlocked even after the passenger alighted (step SB16). Subsequently, the central ECU 10 allows the program update for the image authentication ECU 60 (step SB17).

### [4. Operations of Central ECU of Third Embodiment]

A third embodiment is described next. Since the configuration of the vehicle control system 1 is identical to the first embodiment described above, the description on the configuration of the vehicle control system 1 is omitted.

When an update program for the image authentication ECU 60 is downloaded from the server apparatus 300, the central ECU 10 according to the third embodiment also inquires the key authentication ECU 50 about the communication state with the mobile device 5. In accordance with the communication state between the key authentication ECU 50 and the mobile device 5, the central ECU 10 of the third embodiment changes the operation for a case where a program update for the image authentication ECU 60 fails.

When the communication state between the key authentication ECU 50 and the mobile device 5 is a communication enabled state and if the program update for the image authentication ECU 60 has failed, the central ECU 10 performs a first operation.

As the first operation, the central ECU 10 handles the person carrying the vehicle 3, that is, the mobile device 5 carried by the driver as a first notification destination and, to this first notification destination, transmits a failure notification indicating that the program update for the image authentication ECU 60 has failed. Also, when the mobile device 5 is a smart phone being a digital key, the failure notification is transmitted to an e-mail address or an IP address registered for the smart phone. This failure notification includes a guidance that unlocking of the vehicle 3 by the mobile device 5 and a starting operation to start the drive source such as an engine mounted in the vehicle 3 are necessary.

When the communication state with the mobile device 5 is a communication disabled state and if the program update for the image authentication ECU 60 has failed, the central ECU 10 performs a second operation.

As the second operation, the central ECU 10 handles a contact of a road serving providing company, the person carrying the vehicle 3, that is, the mobile device carried by a family member of the driver as a second notification destination and, to this second notification destination, transmits a failure notification indicating that the program update for the image authentication ECU 60 has failed.

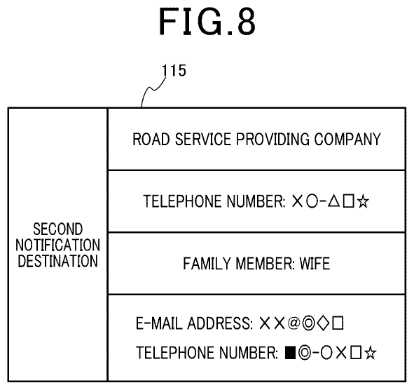

FIG. 8 is a diagram showing an example of a contact table 115 with which an emergency contact is registered.

The second notification destination is registered with the contact table 115.

For the second notification destination, a telephone number of the road service providing company that provides a road service, an e-mail address, a telephone number and the like of a family member of the owner of the vehicle 3 are registered. Also, when the mobile device 5 is a smart phone to be utilized as a digital key, a telephone number or an e-mail address of the owner of the vehicle 3 may be registered as the first notification destination with the mobile device 5.

When the communication state with the mobile device 5 is a communication disabled state and if the program update for the image authentication ECU 60 has failed, the central ECU 10 transmits an e-mail including the failure notification to the e-mail address of the road service providing company and/or the registered mobile telephone of the family member. Also, by calling the telephone number of the road service providing company or the registered mobile phone of the family member, the failure notification may be notified by voice synthesized by voice synthesis software, for example.

Also, in transmitting the program update failure notification to the second notification destination, the central ECU 10 transmits a failure notification including position information on the vehicle 3 acquired from the GNSS sensor 15. Inclusion of position information on the vehicle 3 facilitates to locate the vehicle 3 by the road service providing company and/or the family member.

Moreover, when a program update for the image authentication ECU 60 fails, the central ECU 10 instructs the zone B-ECU 40 to unlock the door lock of the vehicle 3 to forcibly cancel the door lock of the vehicle 3. A passenger may alight from the vehicle 3 without the mobile device 5, and, in this case, a case may be assumed in which unlocking the door lock through image authentication cannot be performed since the program update for the image authentication ECU 60 has failed. Accordingly, the central ECU 10 instructs the zone B-ECU 40 to forcibly cancel the door lock of the vehicle 3.

Furthermore, the central ECU 10 transmits a prohibition instruction to prohibit the zone A-ECU 30 the driving by the drive device 31 to the zone A-ECU 30. Since the door lock of the vehicle 3 is left unlocked, the prohibition instruction is transmitted to the zone A-ECU 30 to prevent the vehicle 3 from running for the purpose of prevention of the vehicle 3 from being stolen.

Also, the central ECU 10 continues to supply the power supplied by the battery 33 to the TCU 14 so that the communication enabled state with outside can be maintained through the TCU 14. Then, for example, the central ECU 10 may cause the touch panel 16 to display the telephone number of the road service providing company or the telephone number registered as the second notification destination, and, if such a telephone number is selected by a touch operation by the passenger, calls the selected telephone number to acquire a state allowing talking.

Also, the registered first notification destination and second notification destination can be changed by a touch operation on the touch panel 16 by a passenger or the like. That is, the notification destination registered as the first notification destination or the second notification destination can be changed by a touch operation. For example, a telephone number of another road service providing company may be registered as the second notification destination, and an e-mail address or telephone number of a smart phone carried by a passenger who is the owner of the vehicle 3 rather than the mobile device 5 may be registered as the first notification destination.

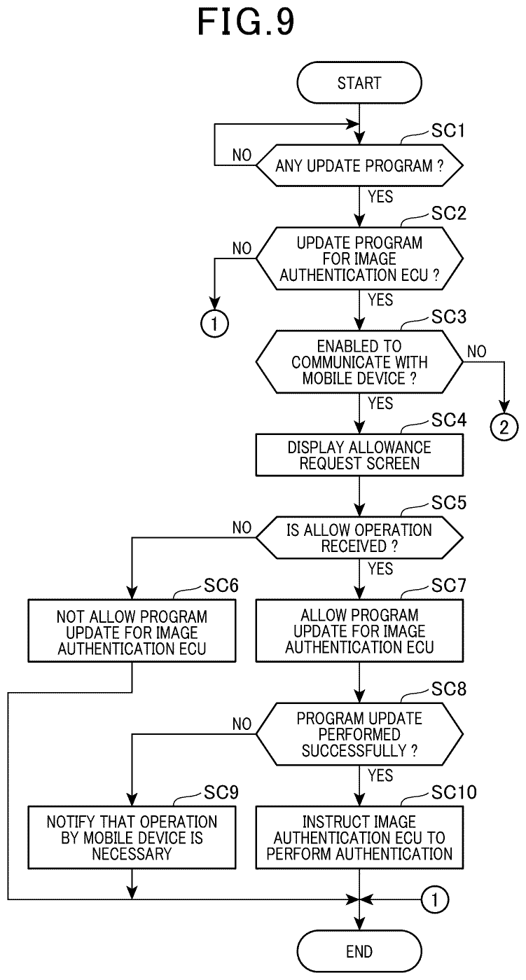

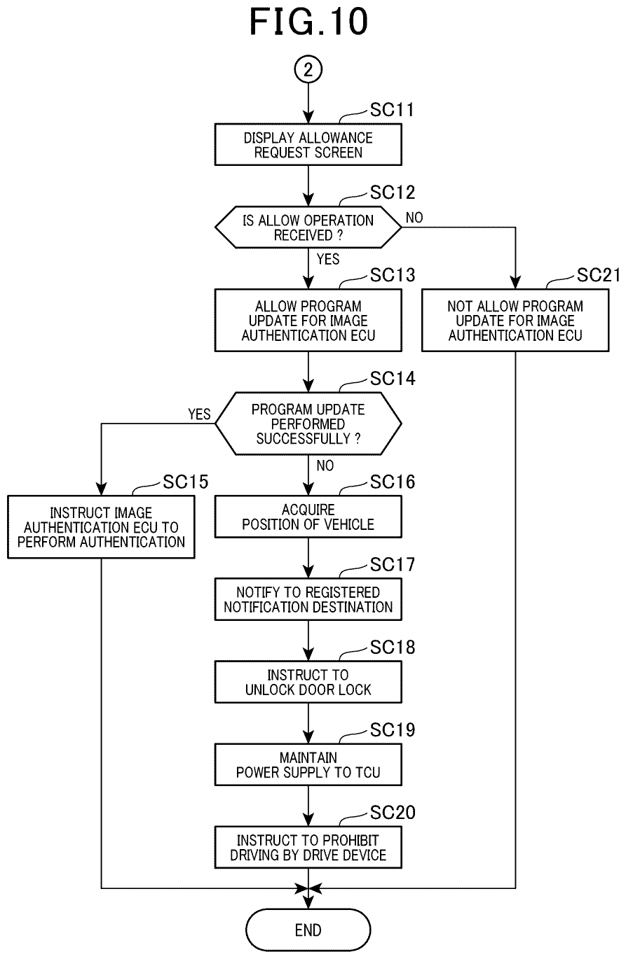

FIGS. 9 and 10 are flowcharts showing operations of the central ECU 10 according to the third embodiment. Operations of the central ECU 10 are described with reference to the flowcharts shown in FIGS. 9 and 10.

The central ECU 10 determines whether there is an update program downloaded from a server, not shown, or not (step SC1). If there is no downloaded update program (step SC1/NO), the central ECU 10 waits until an update program is downloaded from the server.

If there is a downloaded update program (step SC1/YES), the central ECU 10 determines whether the downloaded update program is an update program for the program being executed by the image authentication ECU 60 or not (step SC2).

If the downloaded update program is not an update program for the image authentication ECU 60 (step SC2/NO), the central ECU 10 ends the processing flow and executes another processing flow.

If the downloaded update program is an update program for the image authentication ECU 60 (step SC2/YES), the central ECU 10 inquires the key authentication ECU 50 about whether the communication state with the mobile device 5 is enabled or not. If acquiring a response that the communication state with the mobile device 5 is communication-enabled from the key authentication ECU 50 (step SC3/YES), the central ECU 10 causes the first setting screen 200 shown in FIG. 3 to be displayed on the touch panel 16 (step SC4). In order to allow the program update, the passenger selects the radio button 151 and presses the OK button 155. Also, in order not to allow the program update, the passenger selects the radio button 153 and presses the OK button 155.

The central ECU 10 determines whether an allowance operation has been received or not (step SC5). If the allowance operation is not received and a denial operation is received (step SC5/NO), the central ECU 10 does not allow the image authentication ECU 60 to update the second program (step SC6).

If the allowance operation is received (step SC5/YES), the central ECU 10 allows the image authentication ECU 60 the program update (step SC7).

Subsequently, the central ECU 10 determines whether the program update for the image authentication ECU 60 has been successfully performed or not (step SC8). If the program update for the image authentication ECU 60 has not been successfully performed (step SC8/NO), the central ECU 10 notifies the mobile device 5 that key authentication with the mobile device 5 is necessary (step SC9). In this case, the central ECU 10 notifies the mobile device 5 that the program update for the image authentication ECU 60 has failed.

Also, if the program update for the image authentication ECU 60 has been successfully performed (step SC8/YES), the central ECU 10 instructs the image authentication ECU 60 to perform image authentication (step SC10). In this case, the central ECU 10 may transmit a guidance that instructs to perform face authentication to the mobile device 5.

The image authentication ECU 60 causes the camera 65 to capture an image in accordance with the instruction from the central ECU 10 and extracts a face image of the passenger from the captured image. The image authentication ECU 60 extracts a feature value of a face portion included in a captured image by the camera 65 and authenticates a user based on a comparison result between the extracted feature value and a feature value stored in the second memory 61.

Next, operations are described with reference to the flowchart shown in FIG. 10 in a case where, in the determination in step SC3, a response that the communication state with the mobile device 5 is communication-disabled is acquired from the key authentication ECU 50.

The central ECU 10 causes the first setting screen 200 shown in FIG. 3 to be displayed on the touch panel 16 (step SC11). In order to allow the program update, the passenger selects the radio button 151 and presses the OK button 155. Also, in order not to allow the program update, the passenger selects the radio button 153 and presses the OK button 155.

The central ECU 10 determines whether an allowance operation has been received or not (step SC12). If the allowance operation is not received and a denial operation is received (step SC12/NO), the central ECU 10 does not allow the image authentication ECU 60 to update the second program (step SC21) and ends the processing flow.

If the allowance operation is received (step SC12/YES), the central ECU 10 allows the image authentication ECU 60 the program update (step SC13). Subsequently, the central ECU 10 determines whether the program update for the image authentication ECU 60 has been successfully performed or not (step SC14).

If the program update for the image authentication ECU 60 has been successfully performed (step SC14/YES), the central ECU 10 instructs the image authentication ECU 60 to perform image authentication (step SC15), like step SC10. In this case, the central ECU 10 may transmit a guidance that instructs to perform face authentication to the mobile device 5.

Also, if the program update for the image authentication ECU 60 has not been successfully performed (step SC14/NO), the central ECU 10 acquires position information on the vehicle 3 from the GNSS sensor 15 (step SC16). Next, the central ECU 10 refers to the contact table 115 and notifies the notification destination registered as the second notification destination that the image authentication ECU 60 has failed in program update (step SC17). This notification destination may be a road service providing company that provides a road service or a contact of a family member of the owner of the vehicle 3 registered with the contact table 115.

Next, the central ECU 10 instructs the zone B-ECU 40 to unlock the door lock (step SC18) to forcibly unlock the door lock.

Next, the central ECU 10 controls the zone A-ECU 30 such that the power supply to the TCU 14 can be maintained to cause the TCU 14 to be an activated state. For example, in a case where the telephone number of the road service providing company is selected by a touch operation on the touch panel 16, the central ECU 10 calls the selected number via the TCU 14.

Also, the central ECU 10 transmits an instruction to prohibit the driving by the drive device 31 to the zone A-ECU 30 (step SC20).

The aforementioned embodiments are preferred implementations of the present invention. However, the present invention is not limited thereto and can be implemented in various aspects without departing from the spirit and scope of the present invention.

For example, the configuration of the vehicle control system 1 shown in FIG. 1 and the configuration of the central ECU 10 shown in FIG. 2 are shown in terms of the functional configurations, and specific implementations are not particularly limited. In other words, hardware individually corresponding to each of the functional components may not necessarily be implemented, but it is apparently possible to realize a plurality of functional components by executing programs by one processor. Further, a part of the functions realized by software in the aforementioned embodiments may be hardware, or a part of the functions realized by hardware may be realized by software.

Further, the processing unit of the flowcharts shown in FIGS. 4, 7, 9 and 10 are divisions mainly based on processing details thereof for easy understanding of the processing by the central ECU 10, and the present invention is not limited by how the processing is divided into units and the names of the units shown in the flowcharts in FIGS. 4, 7, 9 and 10. Also, the processing of the central ECU 10 may be divided into much more processing units in accordance with the processing details or may be divided such that one processing unit contains much more processing. Also, the order of the processing in the aforementioned flowcharts are not limited to the shown examples either.

### [5. Configurations Supported by the Aforementioned Embodiments]

The aforementioned embodiments are specific examples of the following configurations.

### (Configuration 1)

A vehicle control system, comprising a first control device that acquires first authentication information via wireless communication with a mobile device and controls locking/unlocking of a vehicle based on the acquired first authentication information, a second control device that acquires second authentication information based on a captured image from a camera and controls locking/unlocking of the vehicle based on the acquired second authentication information, a lock mechanism that locks a door of the vehicle, a receiving device that receives an operation, and an update management device that causes a vehicle-mounted display device mounted in the vehicle to display a setting screen that receives a setting of execution allowance for a program update for the second control device and a setting of necessity of locking of the vehicle after alighting in a case where a communication state between the first control device and the mobile device is communication-disabled and an update program for updating a program being executed by the second control device is acquired and that controls the second control device and the lock mechanism in accordance with a setting received on the setting screen.

In the vehicle control system according to Configuration 1, a setting screen that receives a setting of execution allowance for a program update for the second control device and a setting of necessity of locking of the vehicle after alighting is displayed on a vehicle-mounted display device in a case where an update program for updating a program being executed by the second control device is acquired, and the second control device and the lock mechanism are controlled in accordance with a setting received on the setting screen. Therefore, a user can set execution allowance for a program update for the second control device and necessity of locking of the vehicle after alighting. By receiving how a problem that may occur during a program update is to be addressed from a passenger, the convenience of the user can be improved.

### (Configuration 2)

The vehicle control system according to Configuration 1, wherein the update management device causes the setting screen to display a predetermined guidance if the program update for the second control device fails.

In the vehicle control system according to Configuration 2, a predetermined guidance is displayed on the setting screen if the program update for the second control device fails. Thus, the passenger can be caused to recognize that the program update for the second control device has failed.

### (Configuration 3)

The vehicle control system according to Configuration 1 or 2, wherein the update management device includes an alighting detecting unit that detects alighting of a passenger from the vehicle, and, if an operation for selecting that locking of the vehicle after alighting is necessary is received by the receiving device, and if alighting of the passenger is detected by the alighting detecting unit, transmits an instruction signal that instructs locking of a door of the vehicle to the lock mechanism, and performs a program update for the second control device after transmitting the instruction signal.

If the update management device according to Configuration 3 receives an operation for selecting that locking of the vehicle after alighting is necessary, the program update for the second control device is performed by keeping a door of the vehicle locked. Therefore, the program update for the second control device can be performed while preventing the vehicle from being stolen.

### (Configuration 4)

The vehicle control system according to Configuration 1 or 2, wherein the vehicle control system includes a drive source control device that controls a drive source mounted in the vehicle, and the update management device includes an alighting detecting unit that detects alighting of a passenger from the vehicle, and if an operation for selecting that locking of the vehicle after alighting is not necessary is received by the receiving device and if alighting of the passenger is detected by the alighting detecting unit, transmit an instruction signal that instructs prohibition of driving of the drive source to the drive source control device.

According to the vehicle control system of Configuration 4, if an operation for selecting that locking of the vehicle after alighting is not necessary is received and if alighting of a passenger is detected, prohibition of driving of the drive source is instructed to the drive source control device. Thus, even when the vehicle is not locked, the vehicle does not run without driving of the drive source so that the vehicle can be prevented from being stolen.

### (Configuration 5)

The vehicle control system according to Configuration 4, wherein the update management device performs program update for the second control device by keeping a door of the vehicle unlocked without transmitting an instruction signal that instructs locking of the door of the vehicle to the lock mechanism.

According to the vehicle control system of Configuration 5, if an operation for selecting that locking of the vehicle after alighting is not necessary is received, an instruction signal that instructs locking of a door of the vehicle is not transmitted to the lock mechanism. Thus, the program update for the second control device is performed by keeping the door of the vehicle unlocked so that the program update for the second control device fails and the second control device does not operate, the problem that a passenger cannot get on the vehicle does not occur.

### (Configuration 6)

A control method for a vehicle control system, the vehicle control system including a first control device that acquires first authentication information via wireless communication with a mobile device and controls locking/unlocking of a vehicle based on the acquired first authentication information, a second control device that acquires second authentication information based on a captured image from a camera and controls locking/unlocking of the vehicle based on the acquired second authentication information, a lock mechanism that locks a door of the vehicle, a receiving device that receives an operation, and an update management device that manages updating on a program performed by the first control device and the second control device, the control method for the vehicle control system comprising causing a vehicle-mounted display device mounted in the vehicle to display a setting screen that receives a setting of execution allowance for a program update for the second control device and a setting of necessity of locking of the vehicle after alighting in a case where a communication state between the first control device and the mobile device is communication-disabled and an update program for updating a program being executed by the second control device is acquired, and controlling the second control device and the lock mechanism in accordance with a setting received on the setting screen.

In the control method for the vehicle control system of Configuration 6, a setting screen is displayed on a vehicle-mounted display device, the setting screen receiving a setting of execution allowance for a program update for the second control device and a setting of necessity of locking of the vehicle after alighting in a case where an update program for updating a program being executed by the second control device is acquired, and the second control device and the lock mechanism are controlled in accordance with a setting received on the setting screen. Thus, a user can set execution allowance for a program update for the second control device and necessity of locking of the vehicle after alighting. Therefore, by receiving how a problem that may occur during a program update for the vehicle is to be addressed from a passenger, the convenience of the user can be improved.

### REFERENCE SIGNS LIST

1: vehicle control system, 3: vehicle, 3a: first communication line, 3b: first communication line, 4a: second communication line, 4b: second communication line, 5: mobile device, 10: central ECU, 11: ICB, 12: speaker, 13: microphone, 14: TCU, 15: GNSS sensor, 16: touch panel, 17: display, 18: touch sensor, 19: in-vehicle connection link, 20: DMC, 30: zone A-ECU, 31: drive device, 33: battery, 40: zone B-ECU, 41: lighting, 43: window motor, 45: door sensor, 47: door lock mechanism, 49: weight sensor, 50: key authentication ECU, 51: first memory, 53: first processor, 55: LF/RF antenna, 60: image authentication ECU, 61: second memory, 63: second processor, 65: camera, 110: third memory, 111: third program, 113: map data, 115: contact table, 130: third processor, 131: information acquiring unit, 133: alighting detecting unit, 135: program updating unit, 137: determining unit, 150: allowance request screen, 151: radio button, 153: radio button, 155: OK button, 200: first setting screen, 211: radio button, 213: radio button, 215: OK button, 250: second setting screen, 260: first display field, 261: radio button, 263: radio button, 270: second display field, 271: radio button, 273: radio button, 280: OK button, 300: server apparatus, 350: network

1. A vehicle control system, comprising:
a first control device that acquires first authentication information via wireless communication with a mobile device and controls locking/unlocking of a vehicle based on the acquired first authentication information;
a second control device that acquires second authentication information based on a captured image from a camera and controls locking/unlocking of the vehicle based on the acquired second authentication information;
a lock mechanism that locks a door of the vehicle;
a receiving device that receives an operation; and
an update management device that causes a vehicle-mounted display device mounted in the vehicle to display a setting screen that receives a setting of execution allowance for a program update for the second control device and a setting of necessity of locking of the vehicle after alighting in a case where a communication state between the first control device and the mobile device is communication-disabled and an update program for updating a program being executed by the second control device is acquired, and
that controls the second control device and the lock mechanism in accordance with a setting received on the setting screen.

2. The vehicle control system according to claim 1, wherein the update management device causes the setting screen to display a predetermined guidance if the program update for the second control device fails.

3. The vehicle control system according to claim 1,
the update management device:
includes an alighting detecting unit that detects alighting of a passenger from the vehicle; and
if an operation for selecting that locking of the vehicle after alighting is necessary is received by the receiving device, and if alighting of the passenger is detected by the alighting detecting unit, transmits an instruction signal that instructs locking of a door of the vehicle to the lock mechanism, and performs a program update for the second control device after transmitting the instruction signal.

4. The vehicle control system according to claim 1, wherein:
the vehicle control system
includes a drive source control device that controls a drive source mounted in the vehicle, and
the update management device:
includes an alighting detecting unit that detects alighting of a passenger from the vehicle; and
if an operation for selecting that locking of the vehicle after alighting is not necessary is received by the receiving device and if alighting of the passenger is detected by the alighting detecting unit, transmits an instruction signal that instructs prohibition of driving of the drive source to the drive source control device.

5. The vehicle control system according to claim 4, wherein the update management device performs program update for the second control device by keeping a door of the vehicle unlocked without transmitting an instruction signal that instructs locking of the door of the vehicle to the lock mechanism.

6. A control method for a vehicle control system, the vehicle control system including
a first control device that acquires first authentication information via wireless communication with a mobile device and controls locking/unlocking of a vehicle based on the acquired first authentication information, a second control device that acquires second authentication information based on a captured image from a camera and controls locking/unlocking of the vehicle based on the acquired second authentication information, a lock mechanism that locks a door of the vehicle, a receiving device that receives an operation, and an update management device that manages updating on a program performed by the first control device and the second control device, the control method for a vehicle control system comprising:
causing a vehicle-mounted display device mounted in the vehicle to display a setting screen that receives a setting of execution allowance for a program update for the second control device and a setting of necessity of locking of the vehicle after alighting in a case where a communication state between the first control device and the mobile device is communication-disabled and an update program for updating a program being executed by the second control device is acquired; and
controlling the second control device and the lock mechanism in accordance with a setting received on the setting screen.
